(19) United States
(12) Patent Application Publication
(10) Pub. No.: US 2026/0168573 A1
(43) Pub. Date: Jun. 18, 2026

(54) PARKING LOCK CLUTCH

(71) Applicant: TSUBAKIMOTO CHAIN CO., Osaka (JP)

(72) Inventors: Tsubasa Sugiya, Osaka-shi (JP); Yuji Kurematsu, Osaka-shi (JP)

(73) Assignee: TSUBAKIMOTO CHAIN CO., Osaka (JP)

(21) Appl. No.: 19/422,632

(22) Filed: Dec. 17, 2025

(30) Foreign Application Priority Data
Dec. 18, 2024 (JP) 2024-221729

(51) Int. Cl. F16H 63/34

(52) U.S. Cl. CPC F16H 63/3433

(57) ABSTRACT

In order to provide a parking lock clutch with which, by means of a simple structure, the layout freedom when constructing a parking lock system can be improved, and a reduction in size and an increase in lifespan can be realized, a selector drive mechanism for driving a selector that switches the operating mode of the parking lock clutch between a lock mode and a free mode to rotate includes a drive rod that rotates the selector between a locked position in which the operating mode is set to the lock mode and a released position in which the operating mode is set to the free mode, and the drive rod is moved in a direction intersecting a plane perpendicular to the rotation axis.

### BACKGROUND OF THE INVENTION

### 1. Field of the Invention

The present invention relates to, for example, a parking lock clutch suitable for use in constructing a vehicle parking lock system.

### 2. Description of the Related Art

In a known vehicle parking lock system, a plurality of selectable one-way clutches or a plurality of two-way clutches are interposed respectively between a plurality of speed change gear trains and an input shaft or between a plurality of speed change gear trains and an output shaft, and a parking lock that prohibits rotation of the output shaft is established by setting the speed change gear trains of two systems having different gear ratios in a double engagement state (see Japanese Patent Application Publication No. 2022-049749, for example).

In the vehicle parking lock system disclosed in Japanese Patent Application Publication No. 2022-049749, a problem arises in that, in order to establish the parking lock mechanism, the operating mode of the plurality of selectable clutches is controlled so that the selectable clutches are set in a double engagement state, and this not only requires complex control but also leads to an increase in the number of components.

Meanwhile, the applicant of the present invention has proposed a roller ratchet-type selectable clutch (see Japanese Patent Application Publication No. 2024-013414, for example), and considered, to solve the above problem, applying this type of selectable clutch to the construction of a vehicle parking lock system.

The selectable clutch is configured to be capable of switching between a lock mode, in which relative rotation between an outer race and an inner race is prohibited, and a free mode, in which relative rotation between the outer race and the inner race is permitted, by rotating a selector within a predetermined angle range. The selector is formed from a disk-shaped member, for example, and when the operating mode is switched from the lock mode to the free mode, rollers are pushed up outwardly in a radial direction by an outer peripheral surface of the selector so that the rollers are accommodated in roller accommodating portions provided in the outer race.

### SUMMARY OF THE INVENTION

When the selectable clutch described above is used in a parking lock system, for example, a configuration, in which the outer race is fixed and the inner race is made capable of rotating relative to the outer race by connecting the inner race to a shaft element that rotates as a vehicle wheel rotates, may be considered. In this case, for structural reasons, a configuration, in which the selector is formed from a disk-shaped member, for example, and in the lock mode, the rollers are pressed in the radial direction by the inner peripheral surface of the selector so that the rollers are supported by roller support grooves provided in the inner race, may be considered. Moreover, a configuration, in which a selector drive mechanism is constituted by a power transmission mechanism that converts a linear motion along a plane perpendicular to the rotation axis of the selectable clutch into a rotational motion of the selector, for example, may be considered.

However, with this selector driving method, the arrangement of the selectable clutch is greatly limited when constructing the parking lock system, and as a result, a problem arises in that layout freedom is reduced.

The present invention has been designed on the basis of the above circumstances, and an object thereof is to provide a parking lock clutch with which, by means of a simple structure, the layout freedom when constructing a parking lock system can be improved, and a reduction in size and an increase in lifespan can be realized.

The present invention solves the problem described above by providing a parking lock clutch including an outer race, an inner race that is provided coaxially with the outer race and so as to be capable of rotating relative to the outer race, a plurality of rollers disposed between the outer race and the inner race, a biasing member that biases the rollers in a radial direction toward roller accommodating portions provided in one of the outer race and the inner race, a selector configured to be capable of switching an operating mode between a lock mode in which relative rotation of the inner race relative to the outer race is prohibited and a free mode in which relative rotation of the inner race relative to the outer race is permitted, and a selector drive mechanism that drives the selector to rotate, wherein the selector drive mechanism includes a drive rod that rotates the selector between a locked position in which the operating mode of the parking lock clutch is set to the lock mode and a released position in which the operating mode of the parking lock clutch is set to the free mode, and the drive rod is moved in a direction intersecting a plane perpendicular to a rotation axis.

According to the present invention, it is possible to improve the design freedom with respect to the movement direction of the drive rod by means of a simple structure, and therefore, when the parking lock clutch is installed in a vehicle, the layout freedom can be improved, and the parking lock clutch can be configured to have a high level of user-friendliness and can also be reduced in size.

Moreover, by aligning the direction in which the rotation axis of the parking lock clutch extends with the movement direction of the drive rod, a stable operation can be realized with respect to switching of the operating mode.

Furthermore, a load from the roller is received by the roller contact surface configured as an inclined surface such that in the lock mode, a force for rotating the selector in an unlocking direction acts on the roller contact surface, and thus it is possible, by means of a simple structure, to reduce the switching thrust required by the selector drive mechanism to switch the operating mode from the lock mode to the free mode. Hence, the operating mode can be switched easily, and moreover, wear between the selector and the rollers can be reduced. As a result, it is possible to realize an increase in lifespan. In addition, since the movable range of the selector can be reduced, a size reduction can be realized.

Furthermore, when constructing an electric parking lock mechanism in which the selector drive mechanism includes a drive source such as an actuator, it is possible to realize a configuration including an actuator with low thrust, and therefore, likewise in this regard, it is possible to realize a size reduction and also to achieve a reduction in manufacturing cost.

Further, a lock mechanism configured to be capable of fixing the selector in one or both of a locked position and a released position is provided, thus making it possible to prevent the selector from being rotated unintentionally in the unlocking direction in the lock mode, and as a result, the operating mode can be reliably held in the lock mode.

Further, by forming the lock mechanism from a power transmission portion of a drive rod and a rod insertion hole in the outer race, a lock mechanism for holding the selector in the locked position can be realized by means of a simple structure, and moreover, the switching stroke of the drive rod when switching the operating mode can be reduced. As a result, the length of the drive rod can be shortened, enabling a further reduction in size.

Moreover, by providing a standby spring, if the roller accommodating portions and the roller support grooves are not in phase with each other when the operating mode is switched from the free mode to the lock mode, the selector can be prevented from rotating and the standby spring can be compressed such that the parking lock clutch is maintained in a lock standby state. Then, when the roller accommodating portions and the roller support grooves are in phase with each other, a biasing force generated by of the standby spring can be released, thereby allowing the selector to rotate and locking the parking lock clutch. As a result, chipping or damage caused by an impact due to sudden meshing can be reliably prevented, making it possible to extend the lifespan and ensure a high level of safety.

### BRIEF DESCRIPTION OF THE DRAWINGS

FIG. 1 is a perspective view showing a configuration of a parking lock clutch according to a first embodiment of the present invention;

FIG. 2 is a plan view of the parking lock clutch shown in FIG. 1 as seen from one axial end side, with a part thereof omitted;

FIG. 3 is a cross-sectional view taken along a line A-A in FIG. 2;

FIG. 4 is a perspective view showing a configuration of an outer race of the parking lock clutch shown in FIG. 1;

FIG. 5 is a schematic view showing a state in which the outer race and an inner race are intermeshed;

FIG. 6 is a perspective view showing a configuration of a selector of the parking lock clutch shown in FIG. 1;

FIG. 7 is a perspective view showing a configuration of a selector drive mechanism of the parking lock clutch shown in FIG. 1;

FIG. 8A is a cross-sectional view taken along the axial direction and showing an operating state of the selector drive mechanism in a free mode;

FIG. 8B is a front view showing the configuration of main parts of the parking lock clutch in the free mode, with a part thereof omitted;

FIG. 9A is a cross-sectional view taken along the axial direction and showing an operating state of the selector drive mechanism in a lock mode;

FIG. 9B is a front view showing the configuration of the main parts of the parking lock clutch in the lock mode, with a part thereof omitted;

FIG. 10A is a cross-sectional view taken along the axial direction and showing an operating state of the selector drive mechanism in a lock standby state;

FIG. 10B is a front view showing the configuration of the main parts of the parking lock clutch in the lock standby mode, with a part thereof omitted;

FIG. 11 is an exploded perspective view showing a configuration of another example of the parking lock clutch according to the first embodiment of the present invention;

FIG. 12 is a cross-sectional view taken along the axial direction and showing the operating state of the selector drive mechanism in the free mode;

FIG. 13 is a cross-sectional view taken along the axial direction and showing the operating state of the selector drive mechanism in the lock mode;

FIG. 14 is a sectional view taken along the axial direction and showing the operating state of the selector drive mechanism in the lock standby state;

FIG. 15 is a perspective view showing a configuration of a parking lock clutch according to a second embodiment of the present invention;

FIG. 16 is a perspective view showing the configuration of the outer race of the parking lock clutch shown in FIG. 15;

FIG. 17 is a perspective view showing the configuration of the selector of the parking lock clutch shown in FIG. 15;

FIG. 18 is a perspective view showing the configuration of the selector drive mechanism of the parking lock clutch shown in FIG. 15;

FIG. 19 is a cross-sectional view taken along the axial direction and showing the operating state of the selector drive mechanism in the free mode;

FIG. 20 is a cross-sectional view taken along the axial direction and showing the operating state of the selector drive mechanism in the lock mode;

FIG. 21 is a cross-sectional view taken along the axial direction and showing the operating state of the selector drive mechanism in the lock standby state;

FIG. 22 is a perspective view showing a configuration of a parking lock clutch according to a third embodiment of the present invention;

FIG. 23A is a cross-sectional view taken along the axial direction and showing the operating state of the selector drive mechanism in the lock mode;

FIG. 23B is a front view showing the configuration of the main parts of the parking lock clutch in the lock mode, with a part thereof omitted;

FIG. 24A is a cross-sectional view taken along the axial direction and showing the operating state of the selector drive mechanism in the free mode;

FIG. 24B is a front view showing the configuration of the main parts of the parking lock clutch in the free mode, with a part thereof omitted;

FIG. 25A is a cross-sectional view taken along the axial direction and showing the operating state of the selector drive mechanism in the lock standby state; and

FIG. 25B is a front view showing the configuration of the main parts of the parking lock clutch in the lock standby state, with a part thereof omitted.

### DESCRIPTION OF THE PREFERRED EMBODIMENTS

A parking lock clutch according to the present invention will be described below on the basis of the drawings.

### First Embodiment

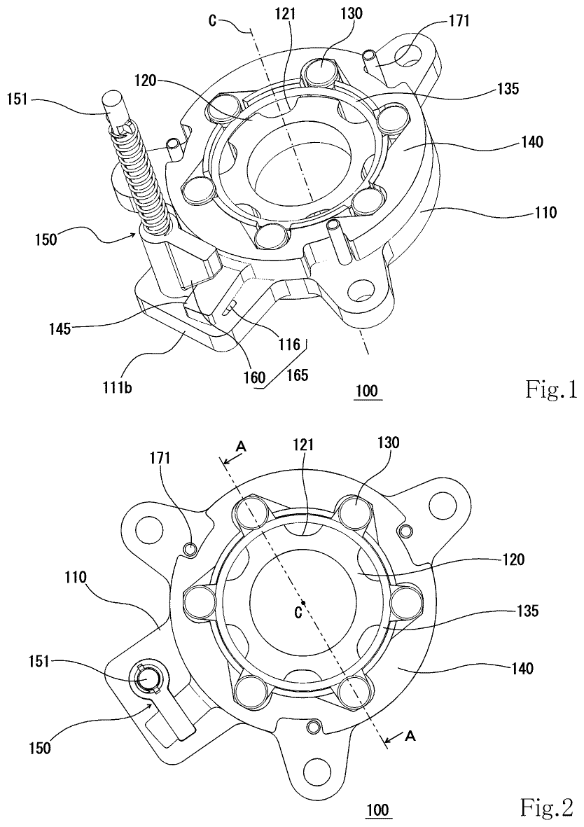

As shown in FIGS. 1 to 3, a parking lock clutch 100 according to this embodiment includes an outer race 110, an inner race 120, a plurality of rollers 130, a biasing member 135, a selector 140, a selector drive mechanism 150, and a retaining plate 170. C in FIGS. 1 to 3 indicates the rotation axis. Note that in FIGS. 1 and 2, for convenience, the retaining plate 170 has been omitted and only a fixing pin member 171 for fixing the retaining plate 170 to the outer race 110 is shown.

As shown in FIG. 4, the outer race 110 includes a base portion 111 having an annular plate 111a and a guide plate 111b. The guide plate 111b is provided integrally on the outer peripheral surface of the annular plate 111a so as to project radially outward. The guide plate 111b is constituted by a plate-shaped body that is rectangular in plan view, and is formed so as to extend along a plane perpendicular to the rotation axis C.

Attachment portions 112 are provided on the outer peripheral surface of the annular plate 111a in positions arranged at predetermined intervals in the circumferential direction, and the attachment portions 112 are fixed to an attachment subject by, for example, fixing bolts (not shown).

A cylindrical portion 113 that extends from the inner peripheral edge to one axial end side is formed on one surface of the annular plate 111a.

Cutouts extending in the axial direction from one axial end edge are provided in positions arranged at predetermined intervals in the circumferential direction of the cylindrical portion 113 so as to form stepped portions 114 in one surface of the base portion 111, and as a result, a plurality of roller accommodating portions 115 corresponding respectively to the plurality of rollers 130 are formed to be capable of accommodating the rollers 130.

An annular stepped portion 113a is formed in an inner peripheral edge on one end side of the cylindrical portion 113 so as to position the biasing member 135 when the rollers 130 are accommodated in the roller accommodating portions 115.

A rod insertion hole 116 into which a drive rod 151 forming the selector drive mechanism 150 is slidably inserted is formed in the guide plate 111b.

The rod insertion hole 116 includes a selector pressing portion insertion portion 116a that is formed to extend in the longitudinal direction of the guide plate 111b and has a rectangular opening shape, and a bearing insertion portion 116b that is formed continuously with one longitudinal side of the selector pressing portion insertion portion 116a and has a circular opening shape.

The inner race 120 is disposed coaxially with the cylindrical portion 113 of the outer race 110 so that the outer peripheral surface thereof is in proximity to and opposed to the inner peripheral surface of the cylindrical portion 113 of the outer race 110, and is provided so as to be capable of rotating relative to the outer race 110.

In the inner race 120, as shown in FIG. 1, a plurality of roller support grooves 121 corresponding respectively to the plurality of rollers 130 are formed in the outer peripheral surface of a cylindrical base so as to extend in the axial direction.

The roller support groove 121 is configured as a concave groove having a substantially flat bottom wall portion and peripheral wall portions that are continuous with both sides of the bottom wall portion and have an arc-shaped cross-portion, and is capable of receiving and supporting a part of the peripheral surface of the roller 130.

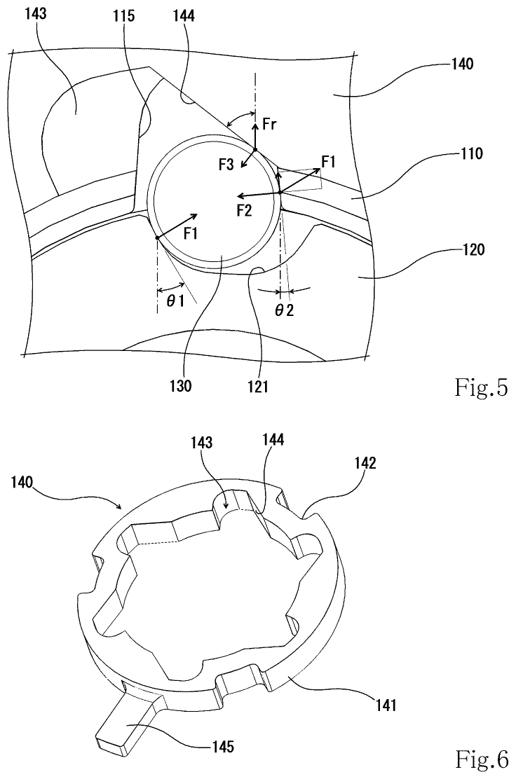

As shown in FIG. 5, an inclination angle θ1 of a roller contact surface at a contact point between the roller 130 and the peripheral wall portions of the roller support groove 121 when the roller 130 is sandwiched in the circumferential direction between the roller support groove 121 and the roller accommodating portion 115 with respect to a reference plane including the rotation axis C and the center of the roller is set at a different magnitude from an inclination angle θ2 of a side wall surface of the roller accommodating portion 115, which serves as a roller contact surface on the outer race 110 side, with respect to the reference plane. Thus, when the roller 130 is sandwiched in the circumferential direction between the roller support groove 121 and the roller accommodating portion 115, a load directed toward the roller accommodating portion 115 side (outwardly in the radial direction) acts on the roller 130.

In this embodiment, the opening edge of the roller support groove 121 has a chamfered shape so that even if the roller 130 attempts to move to the roller support groove 121 side due to an erroneous operation or malfunction of the selector 140 while the inner race 120 is rotating at a certain rotation speed or higher, the roller 130 is repelled by the chamfered portion toward the roller accommodating portion 115 side. Thus, it is possible to prevent the outer race 110 and the inner race 120 from meshing with each other unintentionally, and as a result, a high level of safety can be obtained. Note that the opening edge of the roller support groove 121 may have a rounded shape, for example.

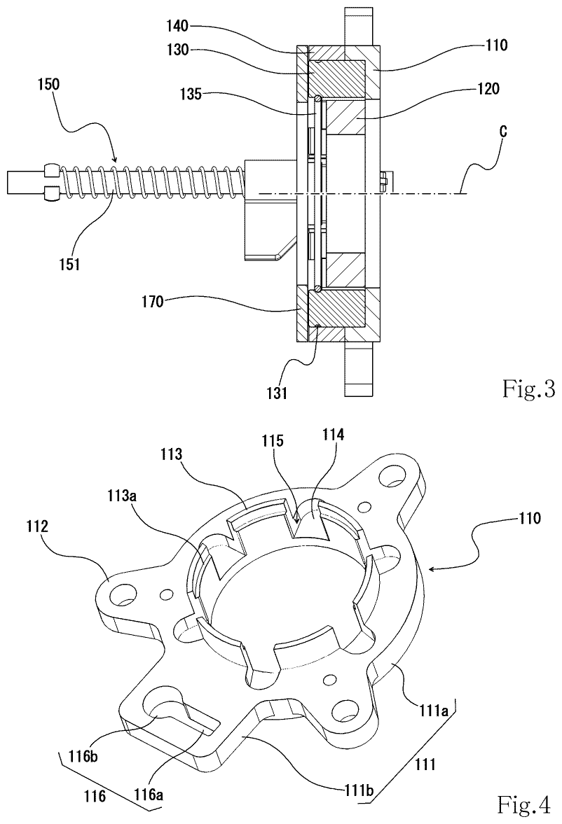

As shown in FIG. 3, each of the plurality of rollers 130 is shaped so as to protrude axially outward beyond one end surface of the inner race 120, and a biasing member mounting groove 131 is formed in the peripheral surface of the protruding part so as to extend around the entire circumference in the circumferential direction.

Movement of each of the plurality of rollers 130 toward the other axial end side is restricted by the stepped portion 114 formed in the base portion 111 of the outer race 110.

In this embodiment, for example, six rollers 130 are arranged in positions arranged at predetermined intervals in the circumferential direction, but there are no particular limitations on the number of rollers 130, and moreover, the arrangement intervals do not have to be equal intervals.

In this embodiment, the biasing member 135 is shared by the plurality of rollers 130 and constituted by, for example, an annular spring.

The biasing member 135 is mounted on the biasing member mounting groove 131 of the roller 130 from the inside in the radial direction so as to bias the rollers 130 radially outward toward the roller accommodating portions 115.

As shown in FIG. 6, the selector 140 includes an annular plate-shaped main body portion 141, and an operating portion 145 provided integrally on the outer peripheral surface of the main body portion 141 so as to protrude radially outward.

The selector 140 is disposed coaxially with the cylindrical portion 113 of the outer race 110 and the inner race 120 in alignment with the outer race 110 in the axial direction in a state where the cylindrical portion 113 of the outer race 110 is inserted slidably into the main body portion 141.

The selector 140 is provided so as to be capable of rotating independently of the inner race 120 between a released position in which the operating mode of the parking lock clutch 100 is set to a free mode and a locked position in which the operating mode of the parking lock clutch 100 is set to a lock mode.

The operating portion 145 is constituted by a rectangular piece-shaped body having an elongated radial dimension in plan view, and is formed so as to extend along a plane perpendicular to the rotation axis C. In this embodiment, the operating portion 145 is positioned so as to overlap the guide plate 111b on the other longitudinal side of the selector pressing portion insertion portion 116a when the operating mode of the parking lock clutch 100 is set to the free mode (the state shown in FIGS. 1 to 3).

Pockets 143 configured so that the rollers 130 can be accommodated in the roller accommodating portions 115 when the selector 140 is rotated in an unlocking direction (for example, clockwise in FIG. 2) in order to switch to the free mode, in which the inner race 120 is allowed to rotate relative to the outer race 110, are formed in the inner circumferential surface of the main body portion 141.

A wall surface of the pocket 143 on a locking direction side is configured as an inclined surface 144 that is inclined in the unlocking direction toward the outside in the radial direction, and when the roller 130 is sandwiched in the circumferential direction between the roller support groove 121 and the roller accommodating portion 115, the inclined surface 144 forms a roller contact surface that receives a radially outward load (including a biasing force generated by the biasing member 135) acting on the roller 130. Furthermore, by rotating the selector 140 in the locking direction, the roller 130 accommodated in the roller accommodating portion 115 can easily be moved in the radial direction toward the roller support groove 121 by the action of the inclined surface 144, and as a result, it is possible to switch from the free mode to the lock mode easily. Moreover, locking can be realized reliably.

Furthermore, a selector rotation restricting concave groove 142 for guiding the fixing pin member 171 as the selector 140 rotates is formed in the outer peripheral surface of the main body portion 141, thereby restricting the range of movement of the selector 140. Thus, the selector 140 can be prevented from overrunning, and as a result, it is possible to switch between the free mode and the lock mode reliably.

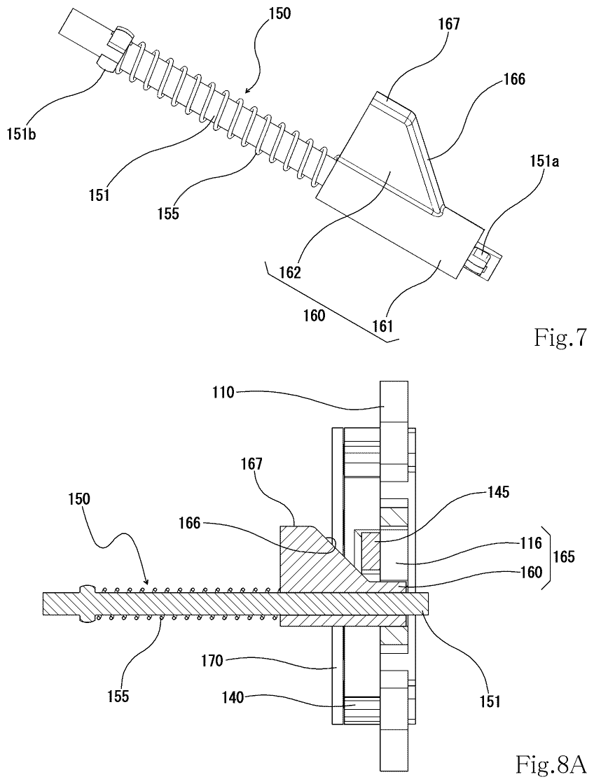

The selector drive mechanism 150, as shown in FIG. 7, includes a drive rod 151, a power transmission portion 160 provided at the tip end of the drive rod 151, and a standby spring 155 constituted by a coiled spring provided with the drive rod 151 inserted therein.

The drive rod 151 is a solid round rod-shaped member having a circular cross-portion, and has a tip end-side engaging portion 151a formed on the peripheral surface on one longitudinal end side and a base end-side engaging portion 151b formed on the peripheral surface on the other longitudinal end side.

The drive rod 151 is provided so as to be capable of reciprocating in the direction of the rotation axis between a first position in which the selector 140 is positioned in the released position and a second position in which the selector 140 is positioned in the locked position.

The power transmission portion 160 includes a cylindrical bearing 161 for slidably supporting the drive rod 151, and a pressing portion 162 provided integrally with the outer peripheral surface of the bearing 161 so as to project radially outward.

The bearing 161 abuts against the tip end-side engaging portion 151a of the drive rod 151 so as to prevent the bearing 161 from falling off the drive rod 151.

The pressing portion 162 is formed from a plate-shaped body having an external shape that conforms to the opening shape of the selector pressing portion insertion portion 116a of the rod insertion hole 116 in the outer race 110 in a plan view of the bearing 161 from the axial direction.

An end surface of the pressing portion 162 on the axial tip end side of the drive rod 151 is formed as a cam surface 166 that inclines toward the axial base end side outwardly in the radial direction of the bearing 161, and when the drive rod 151 moves, the operating portion 145 of the selector 140 is guided along the cam surface 166 so as to cause the selector 140 to rotate.

Further, a side surface of the pressing portion 162 radially outward of the bearing 161 is a flat surface that extends in the axial direction continuously with the cam surface 166, and that, when inserted into the selector pressing portion insertion portion 116a, engages with the inner surface of the selector pressing portion insertion portion 116a and the side surface of the operating portion 145 of the selector 140. In other words, the side surface of the pressing portion 162 radially outward of the bearing 161 functions as a rotation preventing surface 167 that prevents the selector 140 from rotating, while the power transmission portion 160 forms, together with the rod insertion hole 116, a lock mechanism 165 (see FIG. 1) configured to be capable of fixing the selector 140 in the locked position.

The standby spring 155 is provided in a state where one end is abutted against the power transmission portion 160 so as to press the power transmission portion 160 toward the tip end side of the drive rod 151, and the other end is engaged with the base end-side engaging portion 151b of the drive rod 151. Thus, when the selector 140 is rotated in the locking direction so that the selector 140 is positioned in the locked position, the standby spring 155 is elastically deformed in a compression direction.

The retaining plate 170 has an annular plate shape, and is positioned at one axial end side of the selector 140 and fixed to the outer race 110 by the fixing pin member 171. Thus, the constituent members of the parking lock clutch 100 are prevented from coming apart in the axial direction. As shown in FIG. 3, the retaining plate 170 is disposed so as to cover the roller support grooves 121, and thereby also functions as a retainer for the rollers 130.

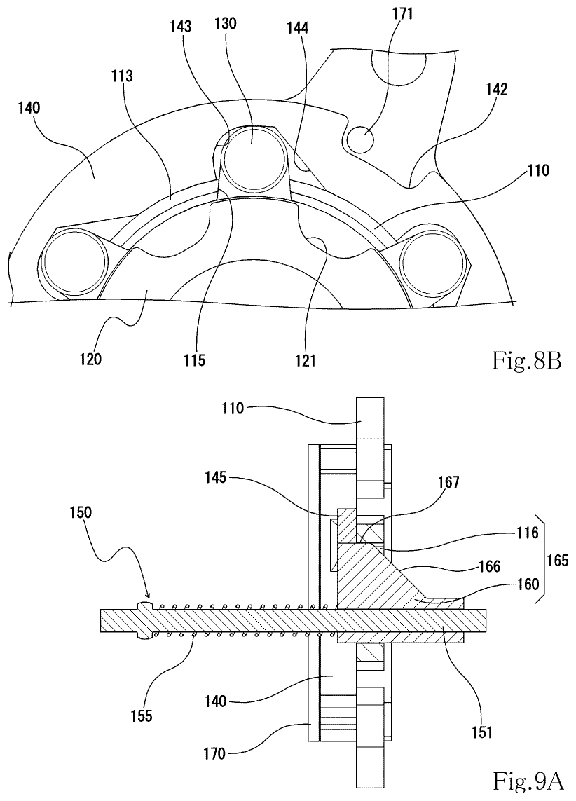

As shown in FIGS. 8A and 8B, in the parking lock clutch 100 described above, when the drive rod 151 is positioned in the first position, the selector 140 is positioned in the released position and the rollers 130 are accommodated in the roller accommodating portions 115 and pockets 143. In other words, the operating mode of the parking lock clutch 100 is set to the free mode in which the inner race 120 is allowed to rotate relative to the outer race 110. At this time, the operating portion 145 of the selector 140 is in contact with the cam surface 166 of the power transmission portion 160.

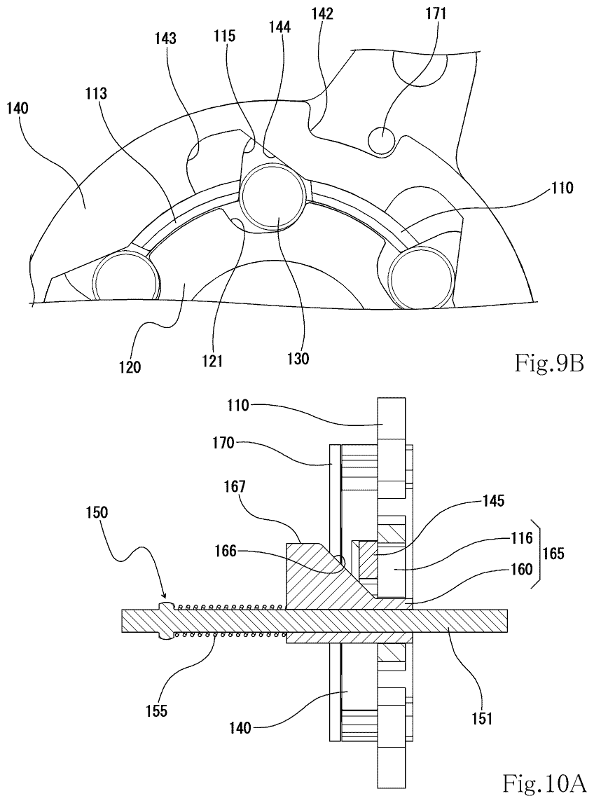

When the drive rod 151 is moved toward the second position, the selector 140 is rotated in the locking direction by the action of the cam surface 166 of the power transmission portion 160. Thus, the rollers 130 accommodated in the roller accommodating portions 115 are moved radially inward toward the roller support grooves 121 against the biasing force of the biasing member 135 by the action of the inclined surfaces 144 of the selector 140. Then, as shown in FIGS. 9A and 9B, when the drive rod 151 is moved to the second position, the rollers 130 are supported by the roller support grooves 121 while being pressed by the inclined surfaces 144 of the selector 140. Meanwhile, the power transmission portion 160 is positioned in the rod insertion hole 116 such that the rotation preventing surface 167 of the power transmission portion 160 is engaged with the inner surface of the rod insertion hole 116 and the side surface of the operating portion 145 of the selector 140. As a result, the operating mode of the parking lock clutch 100 is switched to the lock mode, and the parking lock clutch 100 is held in a state where the selector 140 is prevented from rotating in the releasing direction.

In the lock mode, when rotational torque is input into the inner race 120, as shown in FIG. 5, the rollers 130 receive a pressing force F1 from the roller support grooves 121 in a direction perpendicular to the peripheral wall portions, and are thereby pressed against the wall surfaces of the roller accommodating portions 115. At this time, a force for moving the rollers 130 radially outward in a direction extending along the wall surfaces of the roller accommodating portions 115 acts on the rollers 130, and a radially outward load Fr including the biasing force of the biasing member 135 acts on the inclined surfaces 144 of the pockets 143. In FIG. 5, F2 denotes a normal force exerted on the roller 130 from the roller accommodating portion 115, and F3 denotes a normal force exerted on the roller 130 from the inclined surface 144. More specifically, when rotational torque is input into the inner race 120, the rollers 130 are sandwiched in the circumferential direction between the roller support grooves 121 and the roller accommodating portions 115, and the radially outward load Fr acting on the rollers 130 is supported by the inclined surfaces 144 of the selector 140. As a result, the outer race 110 and the inner race 120 are meshed with each other.

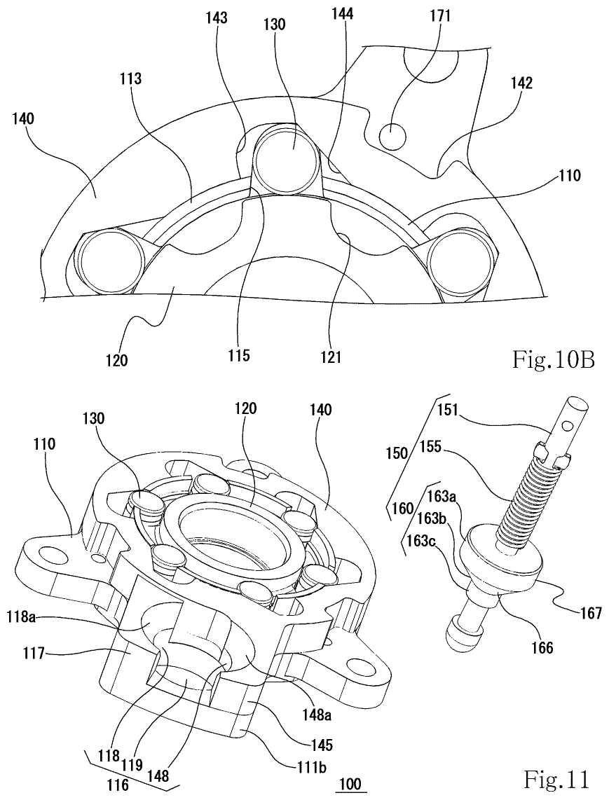

If the roller accommodating portions 115 and the roller support grooves 121 are not in phase with each other when the operating mode of the parking lock clutch 100 is switched from the free mode to the lock mode, the selector 140 is prevented from rotating in the locking direction, and as a result, as shown in FIGS. 10A and 10B, the standby spring 155 is compressed as the drive rod 151 moves. At this time, the parking lock clutch 100 enters a lock standby state. Accordingly, when the inner race 120 is rotating at a certain rotation speed or higher, chipping or damage caused by an impact due to sudden meshing between the outer race 110 and the inner race 120 can be reliably prevented, and as a result it is possible to achieve an increase in lifespan and ensure a high level of safety.

Then, when the roller accommodating portions 115 and the roller support grooves 121 are in phase with each other, the biasing force generated by the standby spring 155 is released such that the selector 140 is rotated in the locking direction. As a result, the rollers 130 are moved radially toward the roller support grooves 121 by the action of the inclined surfaces 144 of the selector 140, whereby the operating mode of the parking lock clutch 100 is switched to the lock mode.

In the parking lock clutch 100 according to the first embodiment, described above, as long as the lock mechanism 165 is configured to be capable of fixing the selector 140 in one or both of the locked position and the released position, the lock mechanism 165 is not limited to the configuration according to the above embodiment.

FIG. 11 is an exploded perspective view showing a configuration of another example of the parking lock clutch according to the first embodiment of the present invention. Hereinafter, identical constituent members to those of the parking lock clutch 100 described above have been allocated identical reference symbols, and description thereof has been omitted.

In the parking lock clutch 100 according to this embodiment, the power transmission portion 160 of the selector drive mechanism 150 has a large-diameter tubular portion 163a with a peripheral surface that forms the rotation preventing surface 167, a pressing portion 163b formed continuously with the tip end of the large-diameter tubular portion 163a, and a small-diameter tubular portion 163c formed continuously with the tip end of the pressing portion 163b. The pressing portion 163b is formed in a truncated cone shape such that the diameter thereof decreases toward the axial tip end side of the drive rod 151, and the peripheral surface thereof functions as the cam surface 166.

The guide plate 111b of the outer race 110 has a plate-shaped outer race-side locking portion 117 on one longitudinal side of one surface thereof. A through hole 119 extending in the axial direction is formed in a longitudinal central portion of the guide plate 111b such that a groove 118 forming a columnar space that is open at the other longitudinal side of the guide plate 111b is formed in the other side surface of the outer race-side locking portion 117. An opening edge of the outer race-side locking portion 117 on the other axial end side of the groove 118 is beveled so as to form a tapered surface 118a that conforms to the peripheral surface of the cone.

A groove 148 forming a selector-side locking portion is formed in one side surface of the operating portion 145 of the selector 140 opposing the outer race-side locking portion 117 so as to extend in the axial direction. The groove 148 is formed so as to form a columnar space that is open on the outer race-side locking portion 117 side. When the other side surfaces of the operating portion 145 and the guide plate 111b are positioned on the same plane, the groove 148 is continuous with the through hole 119 in the guide plate 111b. An opening edge of the groove 148 on the other axial end side is beveled so as to form a tapered surface 148a that conforms to the peripheral surface of the cone.

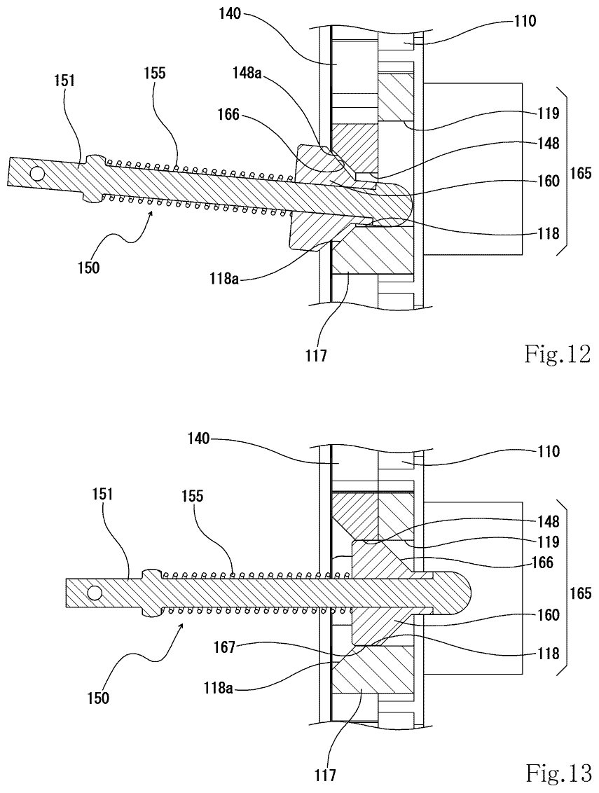

The groove 148 forming the selector-side locking portion is structured to be symmetrical with the groove 118 of the outer race-side locking portion 117, and in this embodiment, the groove 118 of the outer race-side locking portion 117, the groove 148 forming the selector-side locking portion, and the through hole 119 constitute the rod insertion hole 116, and together with the power transmission portion 160 in the selector drive mechanism 150 constitute the lock mechanism 165 (see FIG. 12) configured to be capable of fixing the selector 140 in the locked position.

As shown in FIG. 12, in the parking lock clutch 100 described above, when the drive rod 151 is positioned in the first position such that the operating mode of the parking lock clutch 100 is set to the free mode, a part of the cam surface 166 of the pressing portion 163b of the power transmission portion 160 abuts against the tapered surface 148a of the selector-side locking portion.

When the drive rod 151 is moved toward the second position, the selector 140 is rotated in the locking direction by the action of the cam surface 166 of the pressing portion 163b of the power transmission portion 160. Then, as shown in FIG. 13, when the drive rod 151 is moved to the second position, the large-diameter tubular portion 163a of the power transmission portion 160 is positioned in the through hole 119 such that the rotation preventing surface 167 is engaged with the inner surface of the through hole 119, the inner surface of the groove 118 of the outer race-side locking portion 117, and the inner surface of the groove 148 of the selector-side locking portion. As a result, the operating mode of the parking lock clutch 100 is switched to the lock mode, whereby the parking lock clutch 100 is held in a state where the selector 140 is prevented from rotating in the unlocking direction.

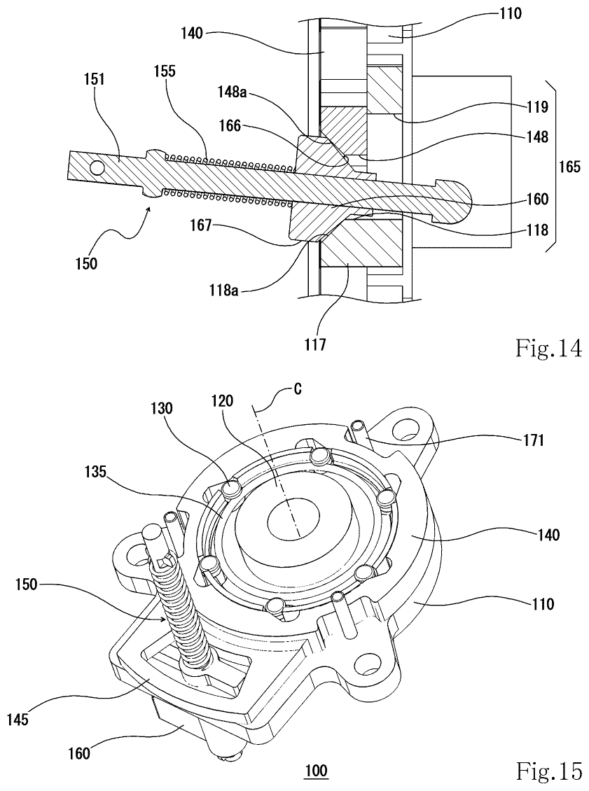

If the roller accommodating portions 115 and the roller support grooves 121 are not in phase with each other when the operating mode of the parking lock clutch 100 is switched from the free mode to the lock mode, the selector 140 is prevented from rotating, and as a result, as shown in FIG. 14, the standby spring 155 is compressed as the drive rod 151 moves. At this time, the parking lock clutch 100 enters the lock standby state. When the roller accommodating portions 115 and the roller support grooves 121 are in phase with each other, the biasing force generated by the standby spring 155 is released such that the selector 140 is rotated in the locking direction by the action of the pressing portion 163b of the power transmission portion 160. As a result, the operating mode of the parking lock clutch 100 is switched to the lock mode.

### Second Embodiment

FIG. 15 is a perspective view showing a configuration of a parking lock clutch according to a second embodiment of the present invention.

The parking lock clutch 100 according to this embodiment has the same configuration as the parking lock clutch 100 according to the first embodiment, described above, except that the lock mechanism 165 provided therein is configured to prevent the selector 140 from rotating unintentionally likewise when the operating mode is set to the free mode. Hereinafter, identical constituent members to those of the parking lock clutch 100 described above have been allocated identical reference symbols, and description thereof has been omitted.

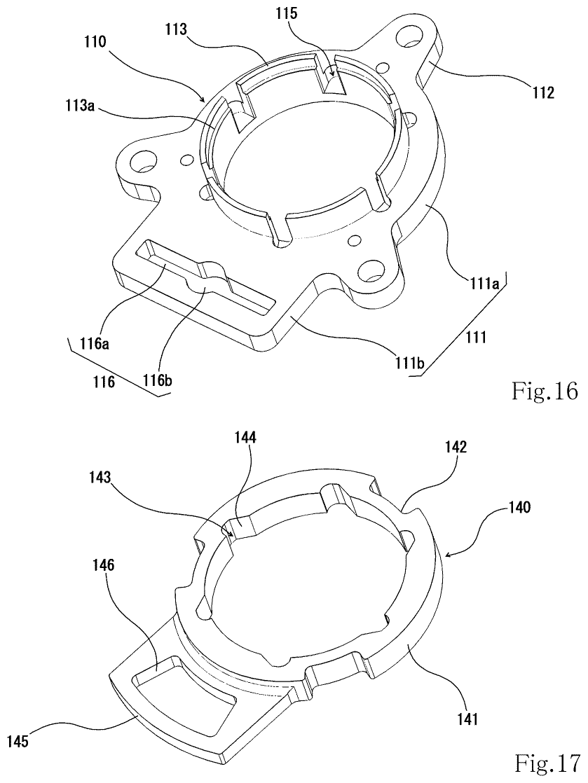

In this embodiment, as also shown in FIG. 16, the rod insertion hole 116 of the outer race 110 is configured such that the bearing insertion portion 116b is formed in a longitudinal central position of the selector pressing portion insertion portion 116a.

In this embodiment, as also shown in FIG. 17, the operating portion 145 of the selector 140 is constituted by a plate-shaped body that is rectangular in plan view, and is formed to extend along a plane perpendicular to the rotation axis C.

The operating portion 145 has a through hole 146 that is positioned so as to overlap the guide plate 111b of the outer race 110 in the axial direction, formed so as to extend in the circumferential direction, and configured such that the power transmission portion 160 of the selector drive mechanism 150 can be inserted therein.

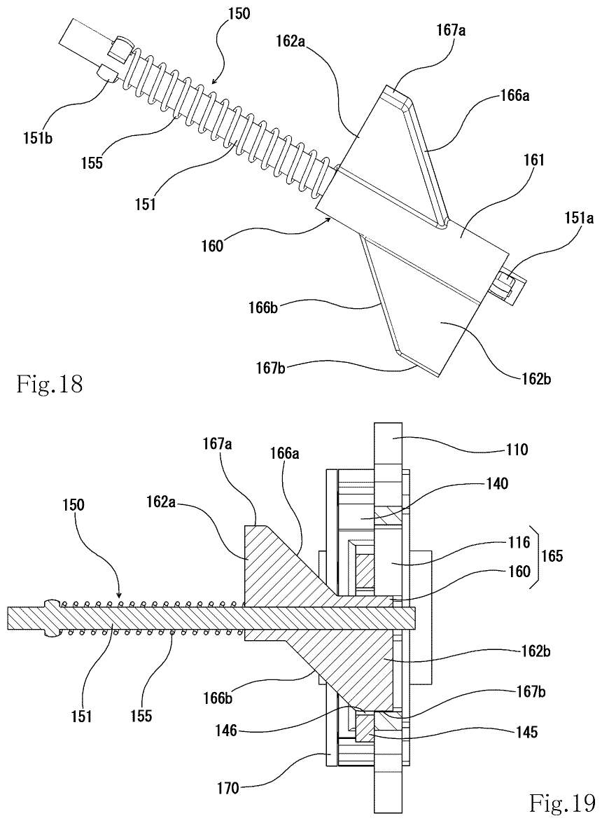

In this embodiment, as also shown in FIG. 18, the power transmission portion 160 of the selector drive mechanism 150 is configured such that a first pressing portion 162a and a second pressing portion 162b are provided integrally in positions on the outer peripheral surface of the bearing 161 facing each other across the central axis of the bearing 161 so as to project outward in the radial direction, and forms, together with the rod insertion hole 116, the lock mechanism 165 (see FIG. 19) configured to be capable of fixing the selector 140 in both the locked position and the released position.

The first pressing portion 162a is formed from a plate-shaped body having an external shape that conforms to the opening shape of a part of the selector pressing portion insertion portion 116a of the rod insertion hole 116 located on the other side of the bearing insertion portion 116b in a plan view from the axial direction of the bearing 161.

An end face of the first pressing portion 162a on the axial tip end side of the drive rod 151 serves as a cam surface 166a that inclines toward the axial base end side outwardly in the radial direction of the bearing 161, while a side surface of the first pressing portion 162a on the radial outside of the bearing 161 is a flat surface that extends in the axial direction continuously with the cam surface 166a, and that functions as a rotation preventing surface 167a.

The second pressing portion 162b is formed from a plate-shaped body having an external shape that conforms to the opening shape of a part of the selector pressing portion insertion portion 116a of the rod insertion hole 116 located on one side of the bearing insertion portion 116b in a plan view from the axial direction of the bearing 161.

An end face of the second pressing portion 162b on the axial base end side of the drive rod 151 serves as a cam surface 166b that inclines toward the axial tip end side outwardly in the radial direction of the bearing 161, while a side surface of the second pressing portion 162b on the radial outside of the bearing 161 is a flat surface that extends in the axial direction continuously with the cam surface 166b, and that functions as a rotation preventing surface 167b.

In the parking lock clutch 100 described above, as shown in FIG. 19, when the drive rod 151 is positioned in the first position and the operating mode of the parking lock clutch 100 is set to the free mode, the rotation preventing surface 167b of the second pressing portion 162b of the power transmission portion 160 engages with the inner surface of the through hole 146 in the operating portion 145 of the selector 140 and the inner surface of the rod insertion hole 116 of the outer race 110, whereby the parking lock clutch 100 is held in a state where the selector 140 is prevented from rotating in the locking direction.

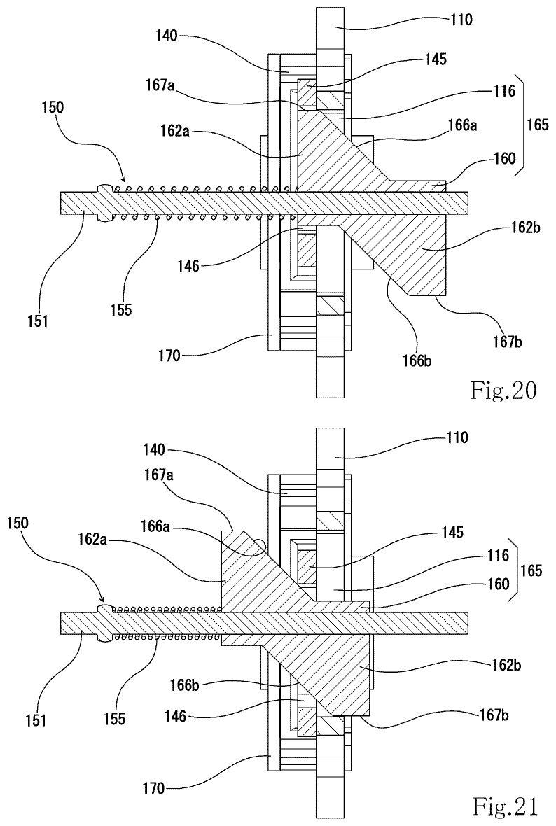

When the drive rod 151 is moved toward the second position, the selector 140 is rotated in the locking direction by the action of the cam surface 166a of the first pressing portion 162a in the power transmission portion 160. Then, as shown in FIG. 20, when the drive rod 151 is moved to the second position, the first pressing portion 162a of the power transmission portion 160 is positioned in the rod insertion hole 116 such that the rotation preventing surface 167a of the first pressing portion 162a is engaged the inner surface of the rod insertion hole 116 and the inner surface of the through hole 146 in the selector 140. As a result, the operating mode of the parking lock clutch 100 is switched to the lock mode, whereby the parking lock clutch 100 is held in a state where the selector 140 is prevented from rotating in the unlocking direction.

If the roller accommodating portions 115 and the roller support grooves 121 are not in phase with each other when the operating mode of the parking lock clutch 100 is switched from the free mode to the lock mode, as shown in FIG. 21, the standby spring 155 is compressed as the drive rod 151 moves. At this time, the parking lock clutch 100 enters the lock standby state. Then, when the roller accommodating portions 115 and the roller support grooves 121 are in phase with each other, the biasing force generated by the standby spring 155 is released such that the selector 140 is rotated in the locking direction. As a result, the operating mode of the parking lock clutch 100 is switched to the lock mode.

### Third Embodiment

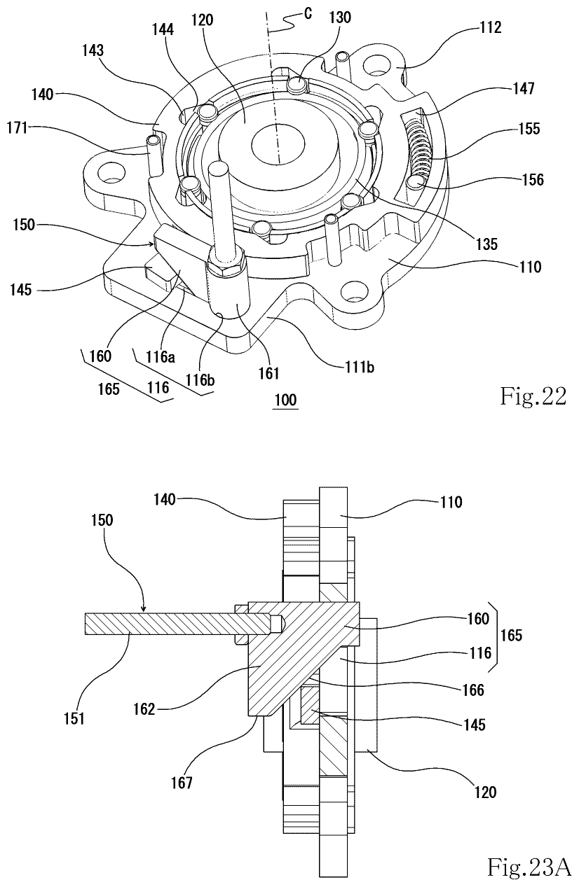

FIG. 22 is a perspective view showing a configuration of a parking lock clutch according to a third embodiment of the present invention.

The parking lock clutch 100 according to this embodiment has the same configuration as that of the parking lock clutch 100 according to the first embodiment, described above, in that the standby spring 155 is provided on the selector 140 and the lock mechanism 165 is configured to prevent the selector 140 from rotating in the locking direction in the free mode. Hereinafter, identical constituent members to those of the parking lock clutch 100 described above have been allocated identical reference symbols, and description thereof has been omitted.

In this embodiment, the rod insertion hole 116 of the outer race 110 is configured such that the bearing insertion portion 116b is formed continuously with the other longitudinal side of the selector pressing portion insertion portion 116a.

In this embodiment, the selector 140 includes a standby spring arranging groove 147 formed so as to extend in the circumferential direction concentrically with the rotation axis C, and the standby spring 155 is disposed in the standby spring arranging groove 147. The standby spring 155 is in a natural state when the operating mode of the parking lock clutch 100 is set to the lock mode, and one end thereof is fixed to a stopper pin 156 fixed to the outer race 110. In other words, when the operating mode of the parking lock clutch 100 is set to the free mode, the standby spring 155 is compressed such that the selector 140 is urged to rotate in the locking direction.

In this embodiment, the operating portion 145 is positioned so as to overlap the guide plate 111b on one longitudinal side of the selector pressing portion insertion portion 116a when the operating mode of the parking lock clutch 100 is set to the lock mode (the state shown in FIG. 22).

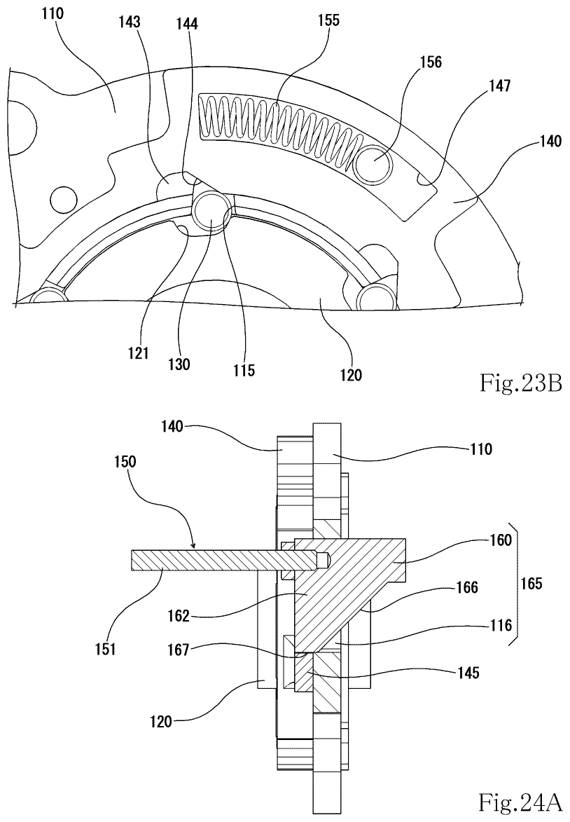

In this embodiment, in the power transmission portion 160 of the selector drive mechanism 150, a side surface of the pressing portion 162 radially outward of the bearing 161 functions as the rotation preventing surface 167 (see FIG. 23A), and together with the rod insertion hole 116, the power transmission portion 160 constitutes the lock mechanism 165 configured to be capable of fixing the selector 140 in the released position.

In the parking lock clutch 100 according to this embodiment, as shown in FIGS. 23A and 23B, when the drive rod 151 is positioned in the second position such that the operating mode of the parking lock clutch 100 is set to the lock mode, the rollers 130 are pressed by the inclined surfaces 144 of the selector 140 so as to be supported by the roller support grooves 121. At this time, the operating portion 145 of the selector 140 is in contact with the cam surface 166 of the power transmission portion 160.

When the drive rod 151 is moved toward the first position, the selector 140 is rotated in the unlocking direction by the action of the cam surface 166 of the power transmission portion 160 while compressing the standby spring 155. As a result, the rollers 130 are biased radially outward by the biasing member 135, whereby the rollers 130 are moved toward the roller accommodating portions 115.

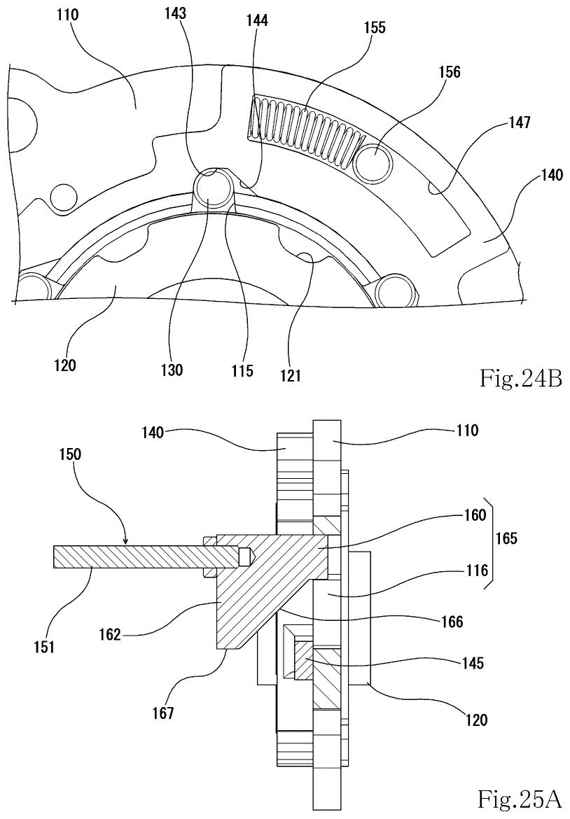

Then, when the drive rod 151 is moved to the first position, as shown in FIGS. 24A and 24B, the rollers 130 are accommodated in the roller accommodating portions 115 and the pockets 143 while the power transmission portion 160 is positioned in the rod insertion hole 116, and thus the rotation preventing surface 167 of the power transmission portion 160 engages with the inner surface of the rod insertion hole 116 and the side surface of the operating portion 145 of the selector 140. As a result, the operating mode of the parking lock clutch 100 is switched to the free mode, whereby the parking lock clutch 100 is held in a state where the selector 140 is prevented from rotating in the locking direction by the biasing force of the standby spring 155.

When the operating mode of the parking lock clutch 100 is switched from the free mode to the lock mode, the drive rod 151 is moved toward the second position, whereby the biasing force of the standby spring 155 is released and the selector 140 is rotated in the locking direction.

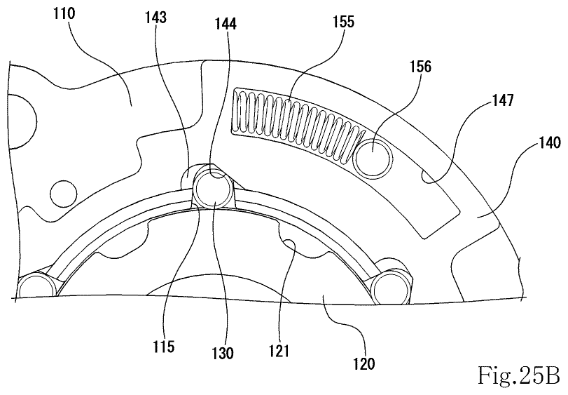

At this time, if the roller accommodating portions 115 and the roller support grooves 121 are not in phase with each other, the selector 140 is prevented from rotating in the locking direction, and as a result, as shown in FIGS. 25A and 25B, the standby spring 155 is maintained in the compressed state such that the parking lock clutch 100 enters the lock standby state.

Then, when the roller accommodating portions 115 and the roller support grooves 121 are in phase with each other, the biasing force generated by the standby spring 155 is released such that the selector 140 is rotated in the locking direction. As a result, the rollers 130 are moved in the radial direction toward the roller support grooves 121 by the action of the inclined surfaces 144 of the selector 140, whereby the operating mode of the parking lock clutch 100 is switched to the lock mode.

In the third embodiment described above, the lock mechanism 165 is configured to prevent the selector 140 from rotating in the free mode, but similarly to the parking lock clutch 100 according to the first embodiment, the lock mechanism 165 may be configured to prevent the selector 140 from rotating in the lock mode. In this configuration, the standby spring 155 may be disposed so as to enter a natural state in the free mode.

The parking lock clutch 100 described above may be applied to either an electric parking lock system in which the drive rod 151 of the selector drive mechanism 150 is driven by a drive source such as an actuator and the operation of the actuator is controlled by an electric signal, or a mechanical parking lock system in which a shift lever in a vehicle is linked to the drive rod 151 by a mechanical link.

Moreover, as long as the parking lock clutch 100 is provided on a shaft element that rotates together with a vehicle wheel, the position thereof is not particularly limited, and the parking lock clutch 100 may be provided on the axle of a drive wheel or a driven wheel, or any one of an input shaft, an output shaft, and an intermediate shaft of a transmission.

Although the embodiments of the present invention have been described in detail above, the present invention is not limited to the above-described embodiments, and various modifications in design may be made without departing from the present inventions as defined in the claims.

For example, in the above embodiments, configurations in which the roller support grooves are formed in the outer peripheral surface of the inner race, the roller accommodating portions are formed in the inner peripheral surface of the outer race, and the biasing member is disposed so as to bias the rollers radially outward were described, but instead, the roller support grooves may be formed in the inner peripheral surface of the outer race and the roller accommodating portions may be formed in the outer peripheral surface of the inner race.

Moreover, as long as the selector drive mechanism is configured to be capable of converting the linear motion of the drive rod into rotary motion of the selector, the selector drive mechanism is not limited to the configurations according to the above embodiments. In addition, the direction of movement of the drive rod is not limited to the direction of the rotation axis, and may be a direction that is inclined with respect to a plane perpendicular to the rotation axis.

The roller contact surface of the selector that comes into contact with the roller in the lock mode need not be an inclined surface, and may be constituted by the inner peripheral surface of the main body portion of the selector.

What is claimed is:

1. A parking lock clutch comprising: an outer race; an inner race that is provided coaxially with the outer race and so as to be capable of rotating relative to the outer race; a plurality of rollers disposed between the outer race and the inner race; a biasing member that biases the rollers in a radial direction toward roller accommodating portions provided in one of the outer race and the inner race; a selector configured to be capable of switching an operating mode between a lock mode in which relative rotation of the inner race relative to the outer race is prohibited and a free mode in which relative rotation of the inner race relative to the outer race is permitted; and a selector drive mechanism that drives the selector to rotate, wherein
the selector drive mechanism includes a drive rod that rotates the selector between a locked position in which the operating mode of the parking lock clutch is set to the lock mode and a released position in which the operating mode of the parking lock clutch is set to the free mode, and the drive rod is moved in a direction intersecting a plane perpendicular to a rotation axis.

2. The parking lock clutch according to claim 1, wherein
the outer race includes a rod insertion hole which is formed to extend in the direction of the rotation axis and into which the drive rod is slidably inserted, and
the selector drive mechanism is configured such that the drive rod is moved in the direction of the rotation axis.

3. The parking lock clutch according to claim 1, wherein
in the lock mode, the rollers are sandwiched in a circumferential direction between the roller accommodating portions and roller support grooves provided in the other of the outer race and the inner race, while the selector presses the rollers against the roller support grooves, and
roller contact surfaces of the selector that come into contact with the rollers in the lock mode are configured as inclined surfaces that are inclined with respect to the circumferential direction.

4. The parking lock clutch according to claim 1, comprising a lock mechanism configured to be capable of fixing the selector in one or both of the locked position and the released position.

5. The parking lock clutch according to claim 4, wherein
the outer race includes a rod insertion hole into which the drive rod is slidably inserted,
the drive rod includes a power transmission portion having a cam surface that is formed to extend at an incline with respect to a plane perpendicular to the rotation axis, and that guides the selector, and a rotation preventing surface that is formed to extend in the direction of the rotation axis continuously with the cam surface, and is configured to be capable of engaging with an inner surface of the rod insertion hole, and
the lock mechanism is constituted by the rod insertion hole and the power transmission portion.

6. The parking lock clutch according to claim 1, comprising a standby spring that is set in a compressed state when the roller support grooves and the roller accommodating portions are not in phase with each other while switching the operating mode of the parking lock clutch.
